(19) United States
(12) Patent Application Publication
(10) Pub. No.: US 2019/0019599 A1
(43) Pub. Date: Jan. 17, 2019

(54) Heated Electrical Wire

(71) Applicants: Kevin Bachynsk, Saskatoon (CA); Clayton Stephanson, Saskatoon (CA)

(72) Inventors: Kevin Bachynsk, Saskatoon (CA); Clayton Stephanson, Saskatoon (CA)

(21) Appl. No.: 15/650,160

(22) Filed: Jul. 14, 2017

(51) Int. Cl. H01B 7/28; H05B 3/56; H01B 7/00; H01B 7/02; H01B 7/04

(52) U.S. Cl. CPC H01B 7/28; H05B 3/56; H01B 7/04; H01B 7/0208; H01B 7/0054

(57) ABSTRACT

The current invention is a heated extension cord. The cord will function like a standard extension cord, allowing a user to use electrical devices in areas without an electrical outlet. The cord will have multiple layers. The cord will have a heated wires layer. The heated wires keeps the insulation from freezing, and ensures the electrical wire stays warm enough to function efficiently. Outside the heated wires are two layers of insulation, one to insulate the heated wires themselves and an outer layer that can directly withstand freezing temperatures. The extension cord has an indicator light and an on/off switch for the heated wires.

### CROSS-REFERENCES TO RELATED APPLICATIONS (IF ANY)

None.

### BACKGROUND

### 1. Field of the Invention

This invention relates to extension cords and particularly ones that are heated and insulated to protect electric wires.

### 2. Description of Prior Art

Power cords are used in outdoor settings for many reasons. The outer layers must be made of a flexible material that also insulates the electric charge carried by the internal wire. The outer material is typically a tough rubber casing. In outdoor workplaces, such as construction sites, the cord is exposed to a variety of extreme weather conditions. In cold weather conditions, the cord can become stiff and brittle. With extended exposure, the rubber cord can crack and render the entire cord dangerous or unusable.

There is still room for improvement in the art.

### SUMMARY OF THE INVENTION

The current invention is an electrical extension cord with heating wires. The cord will remain pliable and undamaged in below freezing conditions. The cord will have multiple layers.

The first layer is the power transmitting wire located at the center of the cord. The second is a rubber coating to insulate the electricity in the power wire. The third is heat transferring wires, such as those used in heated blankets, that surround the insulation layer. The forth layer is a fusible layer to insulate the heat and electricity of the heating wires. The fifth, which is the outermost layer, is a freeze-proof, melt-proof cover.

The heated extension cord will have an ‘on-off’ switch and an indicator light.

It is an improvement over prior art.

### BRIEF DESCRIPTION OF THE DRAWINGS

Without restricting the full scope of this invention, the preferred form of this invention is illustrated in the following drawings:

FIG. 1 shows a cut-away view of the heated extension cord;

FIG. 2 shows the cord from another angle;

FIG. 3 shows another cut-away of the cord;

FIG. 4 shows another cut-away view; and

FIG. 5 is straight on cut-away view.

### DESCRIPTION OF THE PREFERRED EMBODIMENT

There are a number of significant design features and improvements incorporated within the invention.

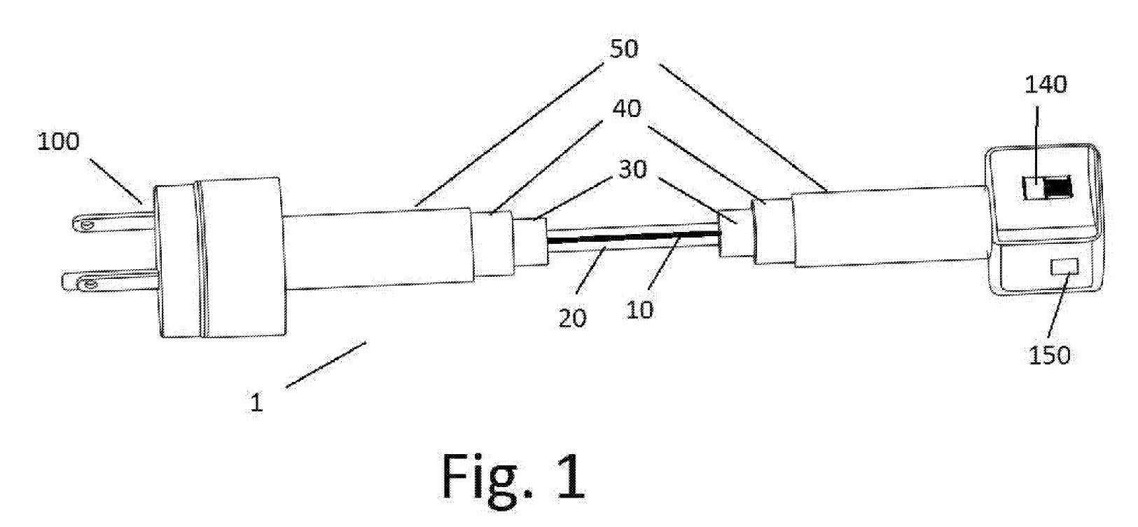

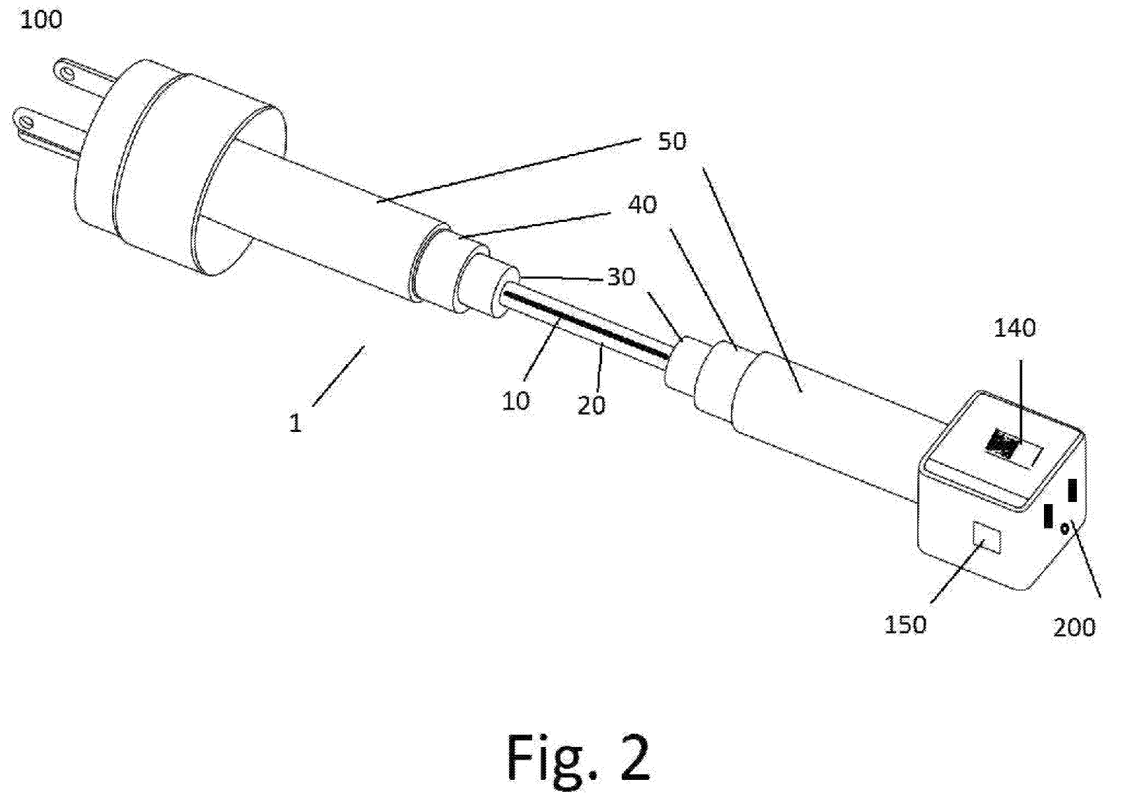

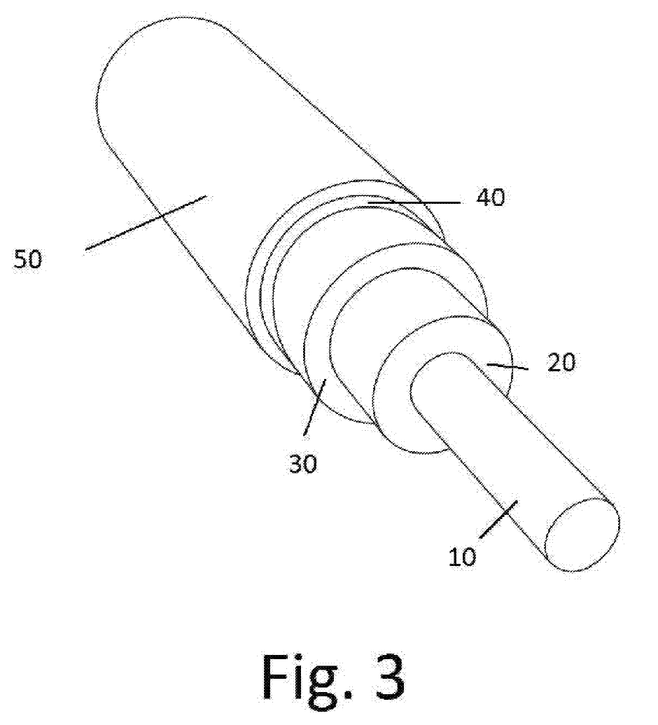

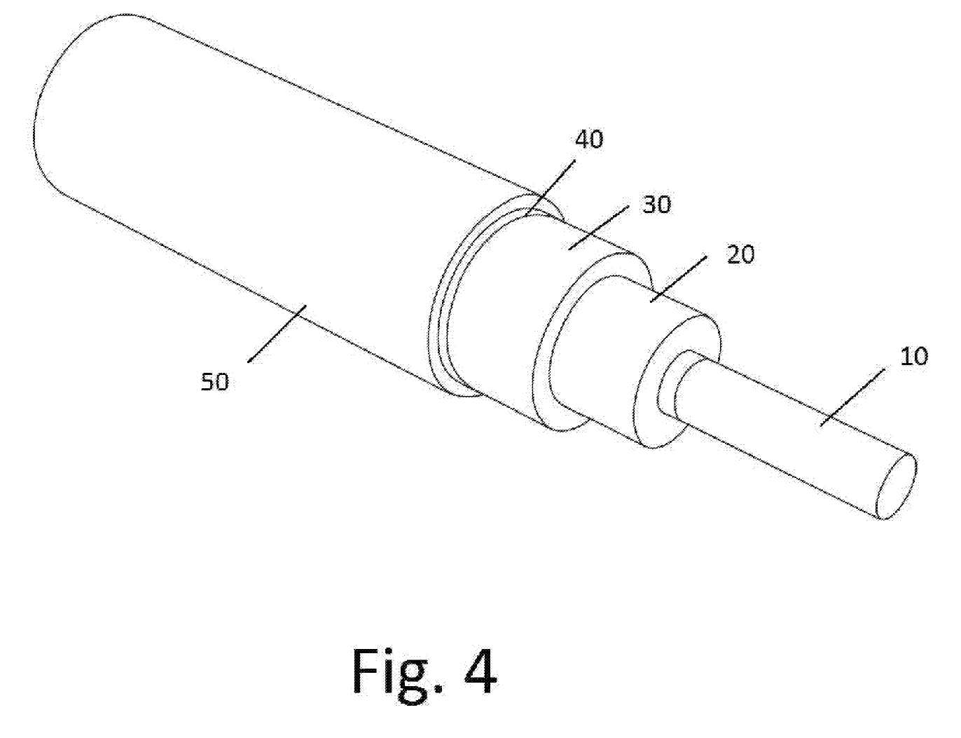

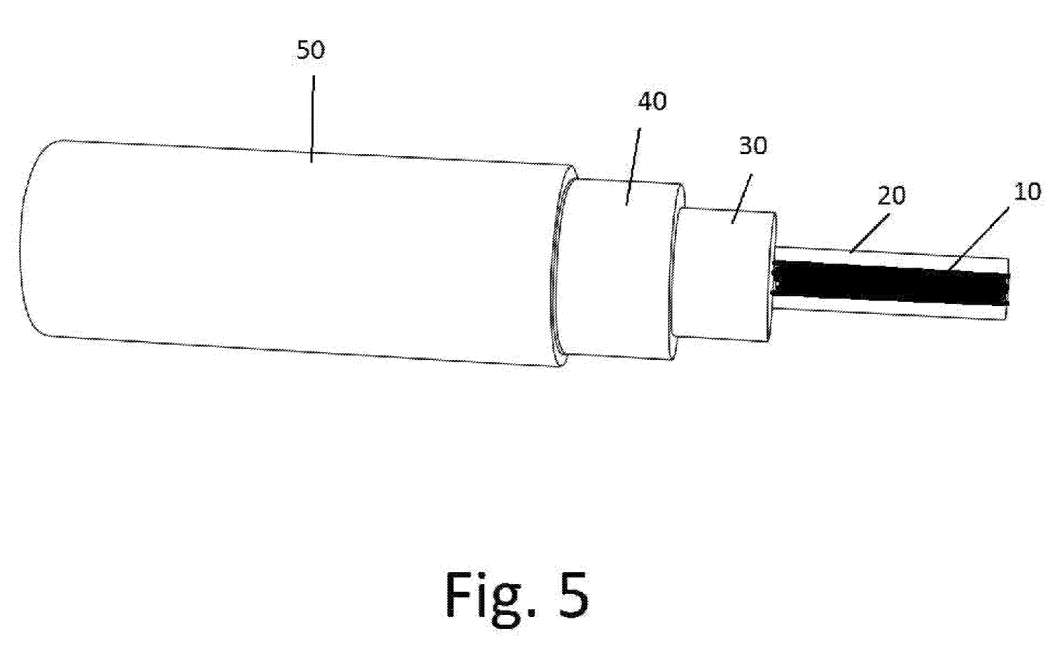

The current invention is an electric extension cord 1 with heating wires 30 as shown in FIGS. 1 through 5. The cord 1 remains pliable and undamaged in below freezing conditions. The cord 1 would have multiple layers, 5 in the preferred embodiment.

The first layer 10 is the primary wire transferring electricity is at the center of the cord. This is the normal electrical wiring made of copper or another material that is efficient at transmitting electricity.

It is surround by the second layer 20. The second layer is a rubber coating layer. This layer provides insulation for the electricity in the primary wire 10.

The third layer 30 surrounds the second layer 20. It is comprised of heat transferring wires 30, such as those used in heated blankets. There is constant power to the heat transferring wires 30 to prevent voltage decrease in cold conditions.

The forth layer 40 is a fusible layer to insulate the heat and electricity of the heating wires 30.

The fifth layer 50, which is the outermost layer, is a protection layer made of a freeze-proof, melt-proof cover. This layer does not need to insulate electricity, so may be made of whatever material is best suited to remaining pliable in freezing conditions. It is made of a material to provide a tough outer jacket that is oil, tear and water resistant, making it perfect for construction yards.

The heated extension cord has an ‘on-off’ switch 140 and indicator light 150 at the receiving end. The on-off switch 140 turns on and off the heat transferring wires 30. The indicator light 150 will be lighted if the heat transferring wires are on.

The heated extension cord has a 3-prong plug 100 and 3-prong outlet 200. The 3-prong plug 100 is at one end of the cord 1 and the 30-prong outlet 200 would be at the other. The cord 1 could also work with a standard 2-prong plug and outlet as well. The primary wire transferring electricity of the first layer 10 forms a circuit from the plug 100 to the outlet 200.

Advantages

The innovative extension cord allows a user to safely and effectively use an extension cord in below-freezing temperatures. The current invention has built-in heating so it keeps the cords above freezing so people can always work.

Although the present invention has been described in considerable detail with reference to certain preferred versions thereof, other versions are possible such as different tension means, bobber shapes and sizes and different colored lights. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A electrical cord comprising:
A electricity transfer wire surround by a insulation layer which is surrounded by a layer of heat transferring wires.

2. A device according to claim 1 further comprising:
Having a fusible layer surround the heat transferring wires layer.

3. A device according to claim 1 further 3comprising:
Having a protection layer surround the fusible layer.

4. A device according to claim 1 further comprising:
Having a plug at one end of the cord.

5. A device according to claim 1 further comprising:
Having an outlet at one end of the cord.

6. A device according to claim 1 further comprising:
Having a plug at one end of the cord and an outlet at the other end of the cord.

7. A device according to claim 6 further comprising:
Having the electricity transfer wire transfer electricity from the plug to the outlet.

8. A device according to claim 4 further comprising:
Having the plug be a 3-prong plug.

9. A device according to claim 4 further comprising:
Having the plug be a 2-prong plug.

10. A device according to claim 5 further comprising:
Having the outlet be a 3-prong outlet.

11. A device according to claim 5 further comprising:
Having the outlet be a 2-prong outlet.

12. A device according to claim 5 further comprising:
Having the outlet be a 2-prong outlet.

13. A device according to claim 1 further comprising:
Having an on-off switch for the layer of heat transferring wires.

14. A device according to claim 13 further comprising:
Having an indicator light for the on-off switch.

15. A electrical cord comprising:
A electricity transfer wire surround by a insulation layer which is surrounded by a layer of heat transferring wires, having a fusible layer surround the heat transferring wires layer, having a protection layer surround the fusible layer and having a plug at one end of the cord and an outlet at the other end of the cord.

16. A device according to claim 15 further comprising:
Having an on-off switch for the layer of heat transferring wires.

17. A device according to claim 16 further comprising:
Having an indicator light for the on-off switch.
